(19) United States
(12) Patent Application Publication
(10) Pub. No.: US 2006/0231196 A1
(43) Pub. Date: Oct. 19, 2006

(54) Perimetrical termination and/or integration strip for textile products, textile products obtained therewith, and method for manufacturing thereof

(75) Inventors: Enrico Zorzi, Lonate Ceppino (VA) (IT); Davide Zorzi, Tradate (VA) (IT)

Correspondence Address: YOUNG & THOMPSON, 745 SOUTH 23RD STREET, 2ND FLOOR, ARLINGTON, VA, 22202, US

(73) Assignee: EMPORIOTESSILE DI ZORZI ENRICO & C.S.A.S., TRADATE (VA) (IT)

(21) Appl. No.: 11/407,531

(22) Filed: Apr. 14, 2006

(30) Foreign Application Priority Data
Apr. 19, 2005 (WO) PCT/IT05/00226
Jul. 22, 2005 (IT) MI2004A001419

(51) Int. Cl. B32B 3/06

(52) U.S. Cl. 156/247; 428/99; 428/100

(57) ABSTRACT

Perimetrical termination and/or insert strips provided with interchangeable decorative elements which may be removably associated by detachable elements and counter-elements to textile products like tableclothes, window curtains, bed spreads and the like for the termination of the textile products. The termination and/or insert strips may have any desired width and decorative elements distributed along one or more parallel lines, wherein the decorative elements are provided reciprocally parallel or offset. The clamping elements are directly applied, for example by seaming, glueing, thermosealing or the like, on a continuous cloth element, wound, during its winding/re-winding, by a simultaneous step by step application phase, by modules with a freely selectable pattern, of the clamping elements provided before cutting the cloth in a longitudinal or cross direction. The obtained products can be used for forming single piece tableclothes, curtains, bedcovers and the like, or perimetral and/or integrating ending strips and the like.

### FIELD OF THE INVENTION

The present invention relates to a perimetrical termination and/or integration strip for textile products as well to textile products obtained therewith according to the preambles of the claims 1 and 2, and to a method for manufacturing said termination and/or integration strips as well as to textile products obtained therewith according to the preamble of the claim 5.

### BACKGROUND OF THE INVENTION

In the tablecloth manufacturing industry it is known to make the perimetrical termination of said tableclothes by means of the application of termination strips which may have any desired color and/or pattern. In said tablecloth manufacturing the tablecloth bodies with the desired sizes are produced which latter are then completed by sewing or thermofixing thereon said termination stripes. In this manner on the one hand the keeping in stock of the tablecloth bodies having different monocolor, kinds of fabrics, fancy designs or pattern and so on is simplified and, on the other hand, the final user is free to choose said perimetrical termination strips according to his personal tastes.

It is implicit the fact that after having chosen the termination strips the tablecloth does not allow any modification of its aesthetic look. From the GB 2,393,118 A1 it is known to removably fasten decorations 7 to a bedding item 2 by means of removable means and counter-means in the form of press studs or hook-and-loop fabrics like Velcro® and similar.

Decorative elements which may be removably fastened by means of the mentioned fastening means and counter-means are also disclosed in the patents U.S. Pat. No. 2,748,517, U.S. Pat. No. 2,692,387 and U.S. Pat. No. 4,890,347 as well as in the U.S. publication No. 2005/0011618 A1.

Window curtains are also known on which animal illustrating drawings are printed, wherein the tails of said animals are formed by a removable element which should be removably fastened on the curtain to the associated animal by means of the above mentioned Velcro® like securing means and counter-means. These curtains are sold by the company IKEA. Each animal has a tail in the form of a typical tail for the respective animal so that the child has to play the game of fastening on the curtain the right tail for each animals. No game variants are provided for.

According to the prior art, the clamping or fixing means applied on the textile product are provided, on a side, in a limited number and, on the other side, they are applied after having manufactured the bedcover or the like, in an individual manner, by seaming, or in a crafty manual manner.

In manufacturing said perimetrical ending and/or integrating strips, it has been found as desirable to rationalize the application of the clamping or fixing means, or counter-means, on the strip or textile product, to reduce the making time while assuring a repeatable application accuracy of said clamping means at their desired positions. This would involve, moreover, a corresponding reduction of the making cost.

### SUMMARY OF THE INVENTION

Starting from the prior art discussed above a first object of the present invention is to suggest termination strips for tableclothes which allow the final buyer or housewife to carry out, if and when desired, a modification of the aesthetic look of said tableclothes.

Another object of the present invention is to use the termination strip suggested for tableclothes also for other textile products, for example bedspreads, window curtains, and similar.

Still another object of the present invention is to use the mentioned termination strips as inserts for the manufacturing of textile products like tableclothes, window curtains, bedspreads and similar by using said termination/insert strips.

A further important object of the present invention is to provide a method for manufacturing textile products with removable decorative elements, allowing said clamping means to be applied on said textile products, according to a specifically provided arrangement or pattern, in a quick and repeatable accurate manner.

A further object of the present invention is to use the made textile products to provide either individual or multiple strips, depending on the cutting of said textile products either in a cross or in a longitudinal direction thereof.

Yet another object of the present invention is to form, after cutting, said textile products processed according to the invention, into semi-finished article of manufactures, ready to be sold.

Another object of the present invention is to allow a plurality of said semi-finished articles of manufacture to be stored in roll forms and used as required.

These objects are achieved with termination and/or insert strips and with textile products like table-clothes, curtains, bedspreaders and the like obtained therewith which present the features of the claims 1 and 2, respectively, and with a method for manufacturing textile products with removable decorative elements, and by the textile products obtained therewith, according to the characteristics of the claim 5.

Further developments and conformations of the termination and/or insert strips according to the present invention as well as of the textile products like table-clothes, window curtains, bedspreads and the like containing said termination/insert strips according to the present invention as well as further preferred embodiments and developments of the method according to the invention and the textile products manufactured therewith are defined in the characterizing parts of the dependent claims.

With the teachings of the invention several important advantages are achieved.

Firstly, in the case of, for example, table-clothes the use of termination strips having decorative elements which may be removably fastened and replaceable by other sets of decorative elements allow, as frequently desired, to utilize table-clothes having a different look for example for the daily use from time to time or for the use during parties and celebrations, for example for birthday parties, school parties, parties with friends and so on by using the same tablecloth with different sets of decoration elements, for example with decorations reproducing flowers of different types, geometrical figures, animals like domestic animals, fishes, wild animals and so on, reproductions of toys, musical instruments, masks (for example in carnival periods), Christmas and Eastern decorations like Christmas trees, leverets, colored eggs and the like. This is easily achieved for the buyers by buying only one tablecloth with a number of sets of decorations either when buying the tablecloth or in a later time. The easy and quick application/removal of said decorations or decorative elements also allow further to wash the proposed tablecloth like any known tablecloth without decorative elements.

The proposed termination strips may have any desired width with one or more rows of fastening means, wherein said fasteners may be distributed with a regular or irregular pitch and reciprocally parallel or offset on more rows.

A further advantage is to be seen in the fact that the mentioned strips may be surely utilized as insert strips, which allows to obtain tableclothes with decorative elements which are also placed in desired places on the tablecloth body, that is on the tablecloth surface lying onto the table. This also permits to obtain tablecloth bodies or lengths which instead of one piece are formed by more pieces like a “mosaic”. In this way for forming a tablecloth it is possible to also use remnants so that the tablecloth may be produced at lower costs.

Said perimetrical and/or insert applications of the proposed decorative strips according to the present invention in addition to the tableclothes can be also used in other textile products like, for example, in window curtains, bed spreads and the like.

A further advantage is that the strips according to the present invention can also be used directly as decorative items for mural tapestry and for decorations to be applied onto walls or to hang to a ceiling as well as to other support elements in a temporarily way for parties and receptions, for Christmas, Easter and carnival periods and the like as well as said strips could be used in clothes, for the decoration of lamps and other items for the decoration of the latter. An advantageous utilization field is to be seen in nursery-schools and primary schools where the interchangeable decorative elements may be of pure decorative or teaching nature, for example in the form of letters and numbers.

Furthermore, with reference to the method suggested by the present invention, the application of the clamping or fixing means receiving the decorative elements on the textile product, for example a curtain, bedcover or the like, is performed in a very short time, with a known simultaneous and accurate application, for example by seaming, glueing or the like, by using known apparatus, for example embroidering or sewing machines, of a multiple operating head type, wherein the continuous application step by step on the continuous cloth during its re-winding allows to reduce the overall required time, or, for the application of all said clamping means over the quite considerable entire length of cloth, which allows to obtain a drastic reduction in production costs of said textile products such as bedcovers, curtains and the like.

Moreover, the application of said clamping or fixing means of the continuous cloth, by a step by step displacement of the cloth, eliminates any further dead times, and the continuous cloth rolls with the clamping means applied thereto, can be advantageously stored and used according to an industrial programming.

A further advantage of the invention is that the application of said clamping means is performed on the continuous cloth, or in coil or roll form, already subjected to all the provided finishing treatments, thereby the textile products, such as curtains and bedcovers, to be cut in a subsequent step or phase, will practically provide semi-finished articles of manufacture ready to be sold and used, wherein the absence of any preparing or finishing operations on the continuous cloth, before and after applying said clamping means, will likewise contribute to eliminating any disadvantageous dead time. Furthermore, the use of continuous cloth elements in their standard widths, for example of 3 m or 3.5 m, will provide cloth strips which, depending on the cross or longitudinal cutting of said cloth, can form the ending and/or integrating strips of the above mentioned PCT/IT2005/000226 patent application, or, by a cross cutting, can directly form curtains of simple or double width, or adapted for windows either of a single or a double wing type, or a bedcover or the like.

A further advantage is that the above mentioned clamping or fixing means can be freely applied/arranged on the continuous cloth: in other words, it is possible to arrange either a single or few clamping means, for example at a central position on said cloth, or a plurality of said clamping means distributed through the overall cross surface of the cloth, for example in a grid pattern, or to provide an asymmetrical arrangement of the clamping means both in a longitudinal and in a cross direction of said cloth.

The modular arrangement of the clamping or fixing means according to the invention allows them to be easily repeatably applied step by step on said cloth, by causing said cloth to be fed step by step by known apparatus, comprising meter counters and adapted to be controlled by a corresponding software, as it is known, for example, in testing/winding machines for testing or controlling and winding continuous fabric cloth elements with a simultaneous rejection of defective cloth portions.

Yet another advantage is that the step by step feeding according to the invention, allows to apply on the continuous cloth element, according to a consecutive succession, either equal or different modules, thereby rationally industrially programming the continuous cloth cut textile products, (such as ending and/integrating strips or single body strips), to be directly used as bedcovers, curtains and the like.

### BRIEF DESCRIPTION OF THE DRAWINGS

Further characteristics, advantages and details of the strips according to the present invention will become more apparent hereinafter from the following disclosure of several embodiments according to the invention, which are schematically shown as examples in the accompanying drawing.

FIGS. 1, 2 and 3 show a tablecloth manufactured according to the known production technics, before the fixing of the termination strips to the tablecloth body, after said application and, in a prospective view, the tablecloth placed onto a table, respectively;

FIG. 4 shows a top view on a termination/insert strip according to the invention on which are visible removable supporting means for decorative elements which are distributed with a regular pitch along a row;

FIG. 5 shows a top view onto a variant of the strips according to the invention on which are also visible removable supporting means for decorative elements which are distributed with a regular pitch and offset along two parallel rows;

FIG. 5A shows a lateral view of a decorative element provided with a removable counter-fastening means;

FIG. 6 shows a top view of a tablecloth having perimetrical termination strips according to the invention;

FIG. 7 shows a top view on a tablecloth similar to that illustrated in FIG. 6 having additionally two transverse insert strips;

FIG. 8 shows a top view similar to that illustrated in FIG. 6 in which the tablecloth besides the termination strips has a longitudinal insert strip,

FIG. 9 shows a top view onto a tablecloth formed by a plurality of termination and insert strips according to the invention;

FIG. 9A shows a tablecloth similar to that of FIG. 9, however formed by transverse insert strips only, that is without termination strips;

FIG. 9B shows a tablecloth which is formed by transverse and longitudinal insert strips only;

FIGS. 10 to 13 show several embodiments of a window or balcony curtain in which

in FIG. 10 only a lower termination strip is provided;

in FIG. 11 additionally two lateral termination strips are provided;

in FIG. 12 additionally a middle insert strip is provided;

in FIG. 13 the curtain is formed by a plurality of termination and insert strips according to the invention;

FIG. 14 shows a perspective view of a bed spread according to the invention;

FIGS. 15 to 24 respectively show a top plan view of a continuous cloth being wound during a modular application of the clamping or fixing means, with a different distribution/arrangement of the latter; and

FIGS. 25 to 31 show examplary textile products obtained from strips of the continuous cloth of FIGS. 15 to 24 and, more specifically

FIG. 25 shows a large curtain for two-wing windows;

FIG. 26 shows two window curtains, each for a window wing;

FIG. 27 shows a modified embodiment of the curtains of FIG. 26;

FIG. 28 shows a bedcover applied on a bed;

FIG. 29 shows a curtain formed by a bottom ending strip, two side ending strips, and an insert strip and two further fabric/remnant strips;

FIG. 30 shows a curtain formed by three strips which can be obtained, for example, by longitudinally cutting the cloth made/finished according to the invention, for example together with strips for other applications/textile products;

FIG. 31 shows a top plan view of an American or breakfast tablecloth, for example of 50×30 cm, made of a fabric material, a non-woven material, bamboo bark strips and so on, with, for example, a decorative element.

### DESCRIPTION OF THE PREFERRED EMBODIMENTS

In the above mentioned figures, like parts have been indicated by like reference characters.

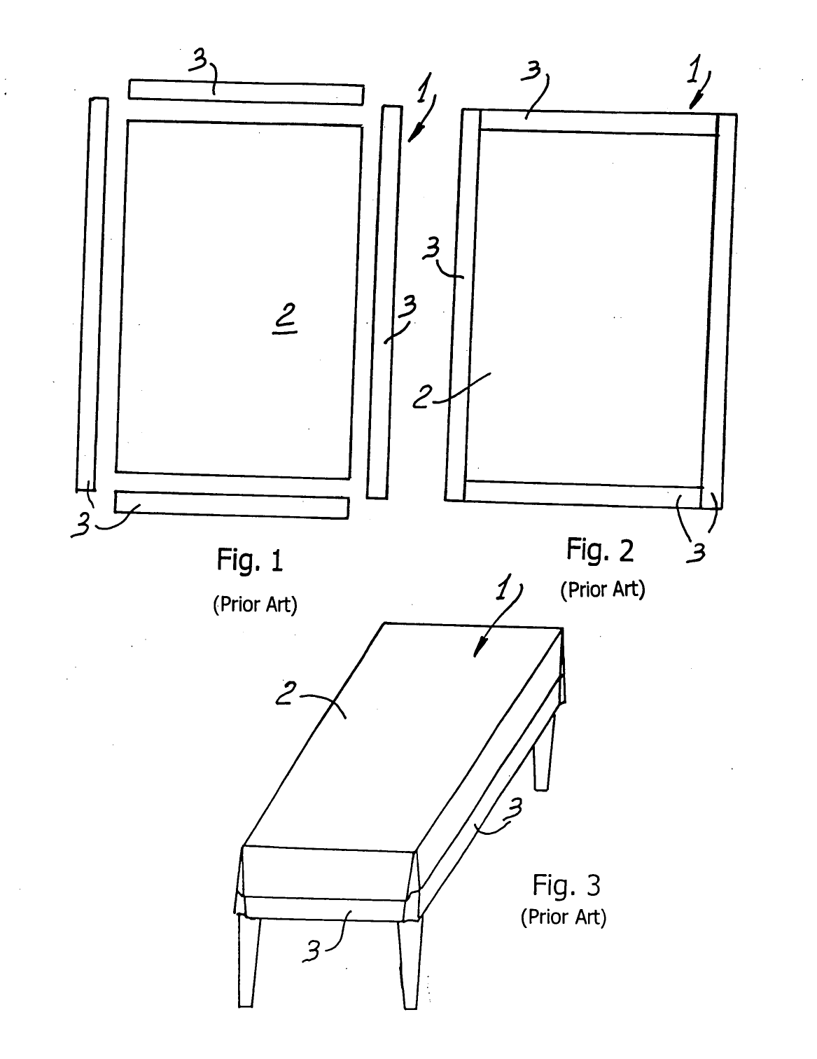

Reference is at first made to FIGS. 1-3 which illustrate the known technic for the manufacturing of tablecloths. The known tableclothes 1 have a tablecloth body 2 which in the shown example has a rectangular shape the sides of which are terminated with four termination strips 3 which latter are cut with the necessary length front a reel and then fixed by sewing or thermofixing to the tablecloth body 2. When finished the tablecloth presents the conformation shown in FIG. 2 and, when placed onto a table, it has a look as visible in FIG. 3.

The known tableclothes have the disadvantages set forth in the introductory part.

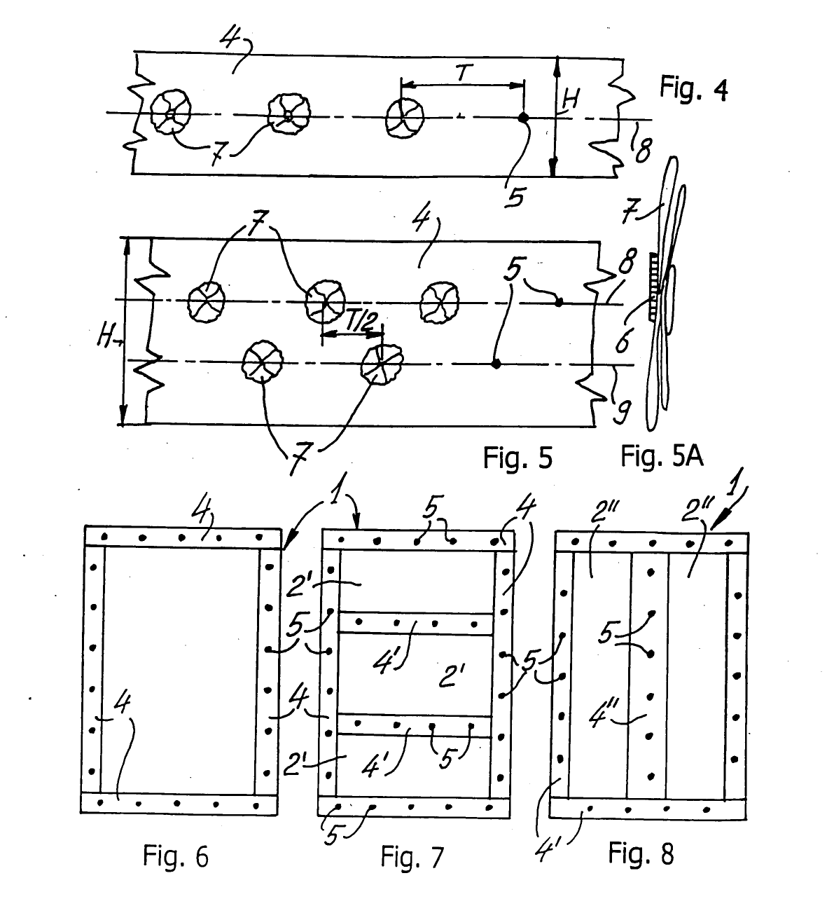

Reference is now made to FIGS. 4 and 5 in which the termination strips 4 according to the invention are provided with a plurality of removable fastening means 5, for example in the form of small disks formed by hook-and-loop fabric of Velcro® type, the fastening counter-means 6, for example likewise in the form of small disks of Velcro® type, are secured to decorative elements 7 having a conformation at will, as set forth in the introductory part, in the shown example as flowers.

In the shown example said decorative elements 7 are at a regular distance or pitch S from each other. While in FIG. 4 said decorative elements 7, or said fastening small disks 5 are placed along an imaginary line 8, in the example of FIG. 5 said decorative elements 7 are distributed along two imaginary lines 8 and 9, and more precisely with a regular pitch T and offset from each other by a half-pitch T/2.

The termination and/or insert strips according to the present invention may be used in the tablecloth manufacturing in more different ways.

In the tablecloth 1 of FIG. 6 the tablecloth body 2 is terminated with perimetral strips 4 while in the embodiments shown in FIGS. 7 and 8 besides said perimetrical termination strips 4 are provided two transverse strips 4′ in FIG. 7 or a middle longitudinal strip 4″ in FIG. 8. Therefore, in the tableclothes of the FIGS. 7 and 8 the tablecloth body or length is no more provided in only one piece but it is formed of several partial bodies 2′ or 2″, respectively, for which remnants may be used, which are cheaper with respect to the tablecloth body 2 of FIG. 6 having a greater surface.

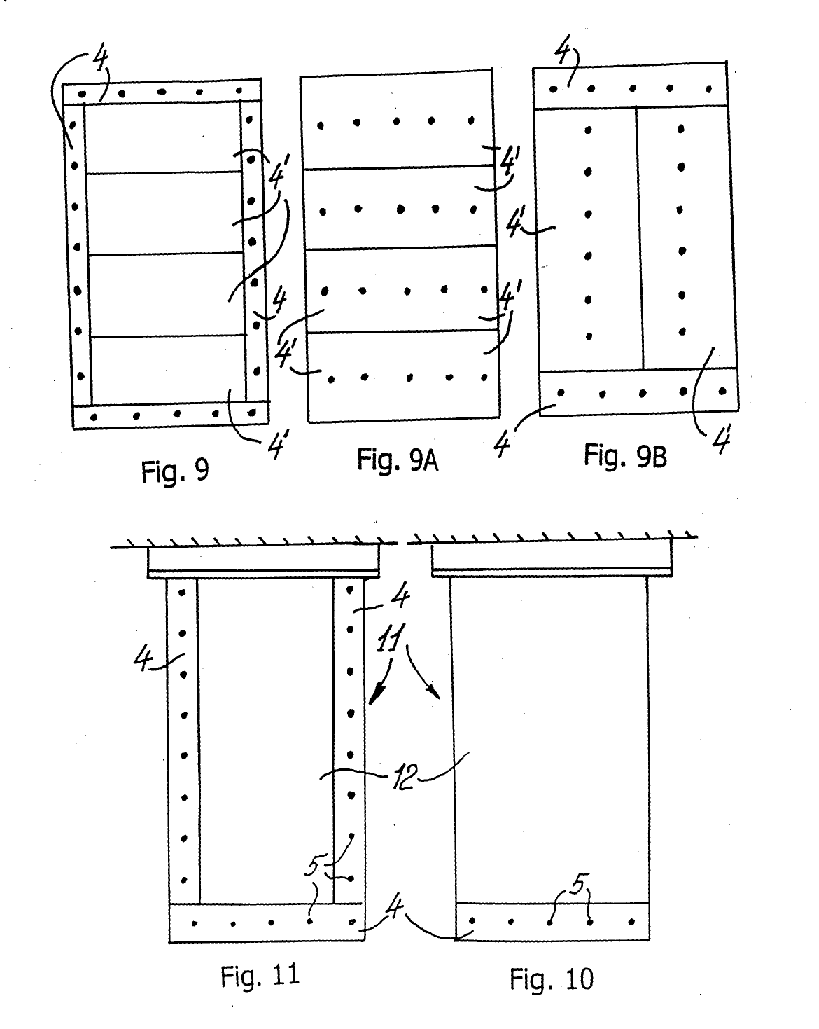

The strips 4 according the invention may have any desired width h in the field ranging, for example, from a few cm, for example 3 cm, to 50 cm and more, wherein each strip 4 can have, according to the provided width, one or more rows of decorative elements 7. In this way according to the invention it is further possible to manufacture tableclothes formed by a plurality of termination strips 4 or insert strips 4′, 4″ only, as shown in the FIGS. 9 and 9A. Also in this way it is possible to use fabric remnants which latter are considerable cheaper than the known tablecloths formed by a tablecloth body 2 having an important width and length.

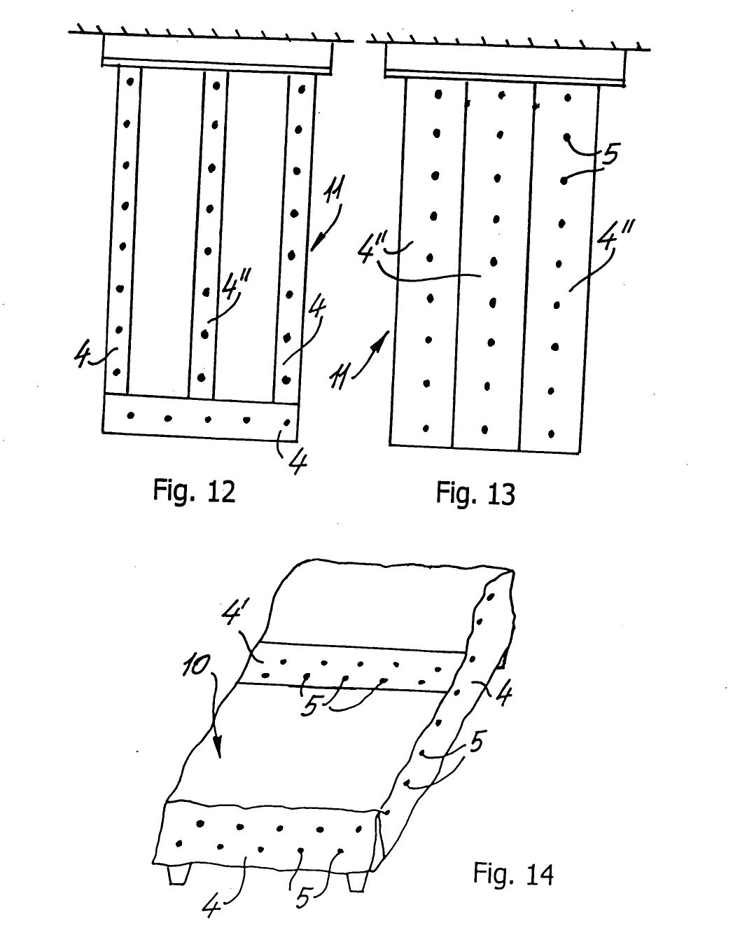

What said in relation to the tablecloth 1 is also similarly valid for other textile products, in particular for bed spreads (FIG. 14) or window or balcony curtain or curtains (FIG. 10-13), respectively. In particular for window curtain and curtains it is thinkable a plurality of utilizations of the termination 4 and insert 4′, 4″ strips according to the invention. In FIG. 10 the shown curtain 11 has a curtain body 12 and a single lower termination strip 4. In the embodiment of FIG. 11 the curtain 11 has additionally two lateral termination strips 4, wherein in the embodiment of FIG. 12 it has an additional middle longitudinal insert strip 4″.

In the curtain 11 of FIG. 13 said curtain is formed by longitudinal or vertical insert strips 4″ only. How explained above for the tableclothes 1, the bed spreads 10 and the curtains 11 the illustrated embodiments advantageously allow the use of cheaper remnants 2′, 2″ or the use of insert 4′, 4″ and termination 4 strips only, wherein it is always possible a remarkable aesthetic look with very low costs. To notice is here that today the costs of decorative elements of synthetic material are very low.

The termination and insert strips provided with decorative elements may be produced with monocolor or multicolor or embroidered fabrics at will as now known and the described removable fastening means and counter-means like small disks of Velcro® type may be replaced by other functionally equivalent fastening means.

The scope of the invention also includes the products manufactured with the termination and/or insert strips according the invention like tableclothes, bed spreads and curtains having any arrangement of said termination and/or insert strips.

Practically also the decorative elements as well as sets thereof may have any conformation at will.

With reference at first to FIGS. 15 to 24, the reference number 15 shows a continuous cloth element which is unwound from a bobbin 16 and wound onto a bobbin 17, the reference number 18 showing a cloth portion unwound from the cloth 15 to be processed and the reference number 19 shows the selvedges of the cloth 15.

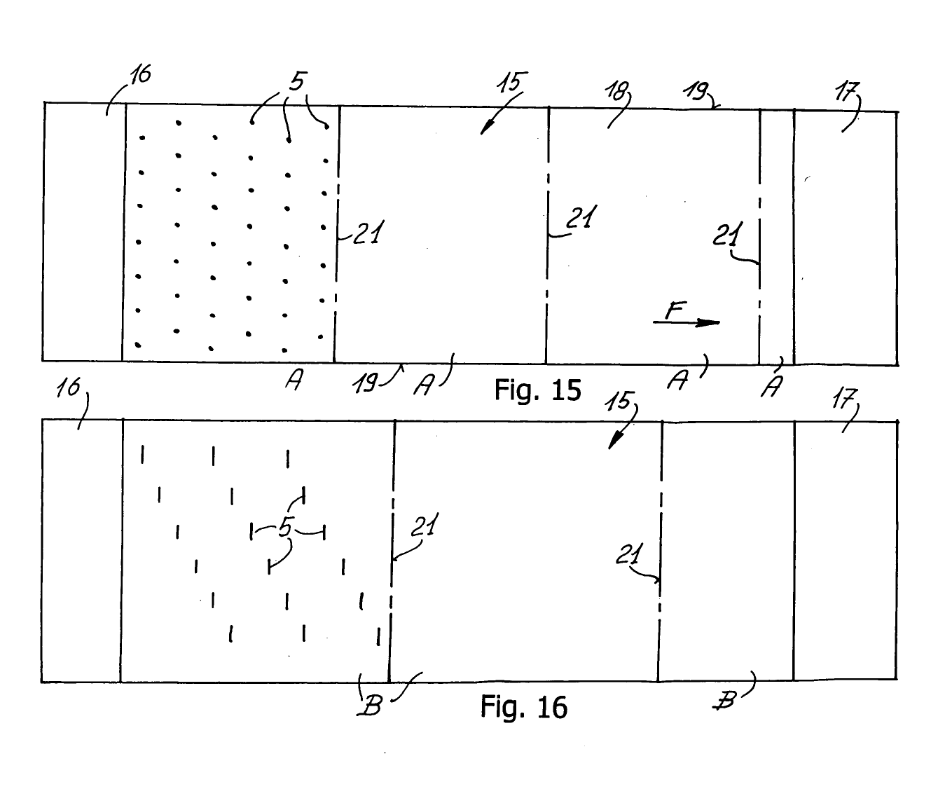

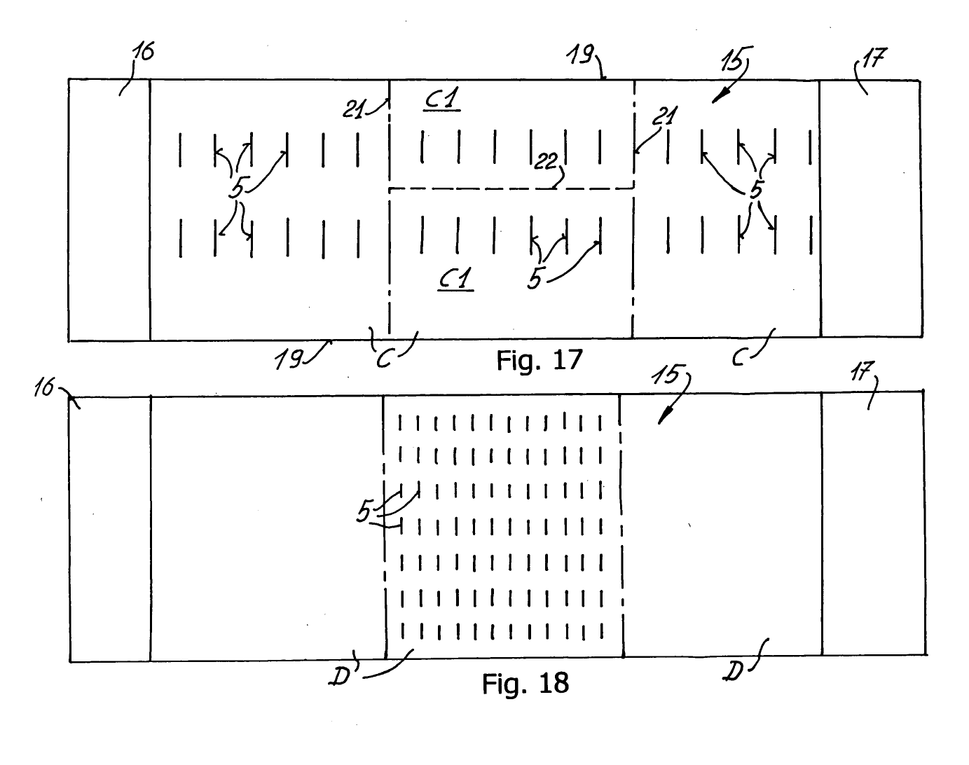

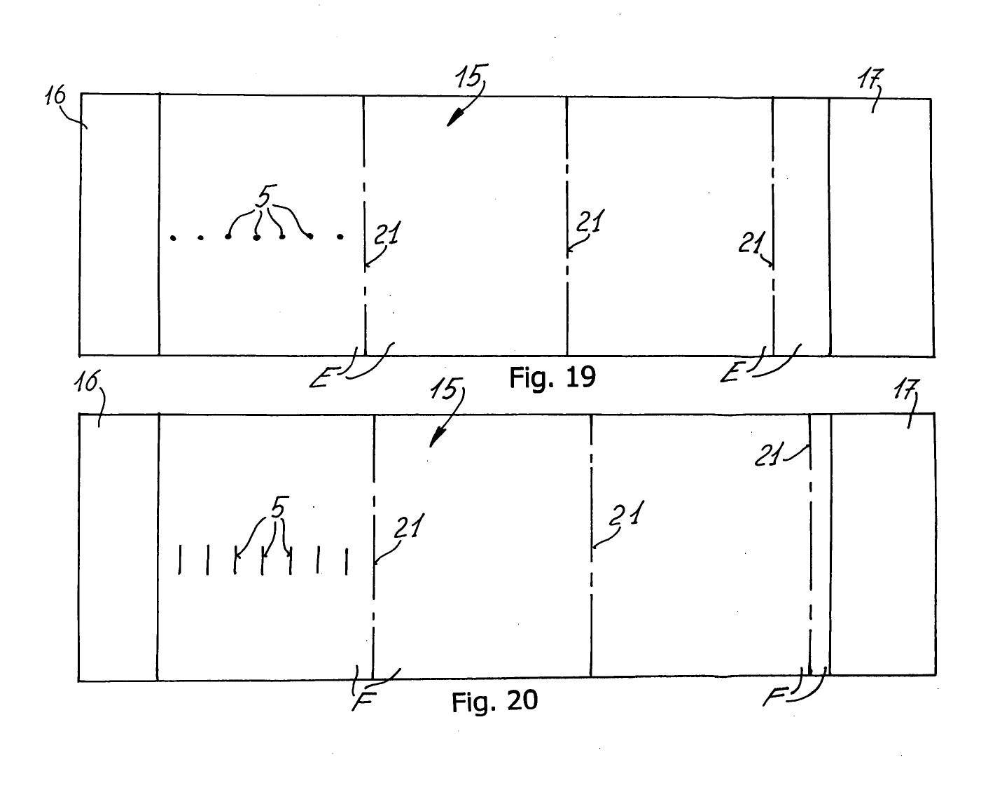

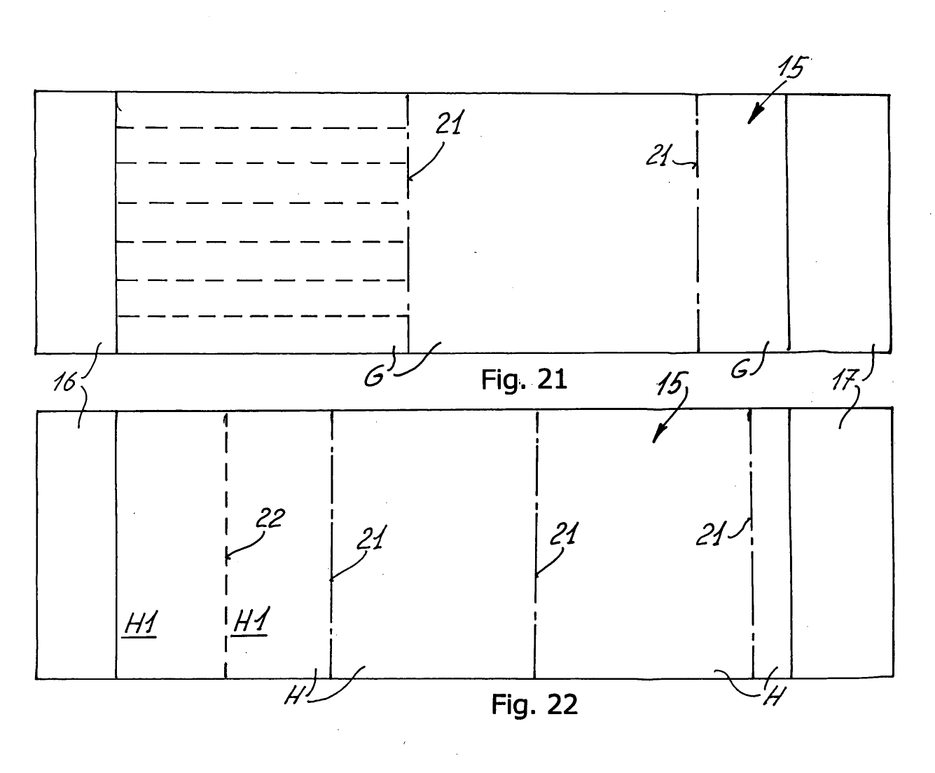

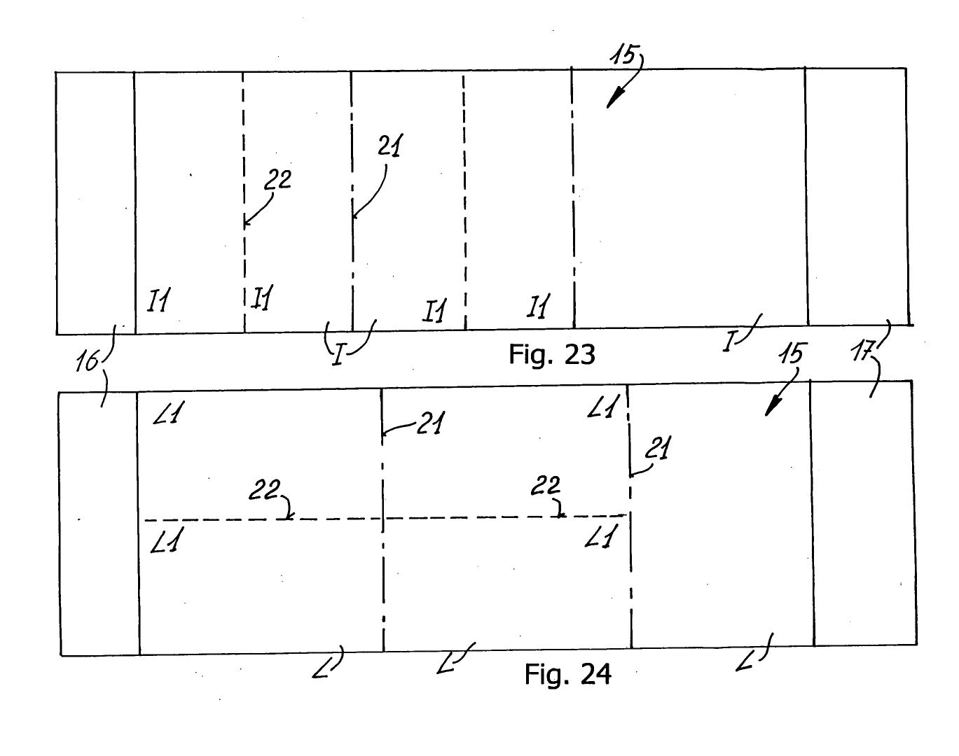

According to the invention, on the continuous cloth 15, which has been already subjected to all the necessary finishing treatments, depending on its construction of natural, synthetic or mixed fibers, before cutting therefrom fabric pieces to form textile products such as curtains, bedcovers and the like, clamping or fixing means 5 are applied, according to freely selectable arrangement or pattern modules thereof as shown, for example, by the modules A in FIG. 15, B in FIG. 16, C in FIG. 17, D in FIG. 18, E in FIG. 19, F in FIG. 20, G in FIG. 21, H in FIG. 22, 1 in FIG. 23 and L in FIG. 24.

As shown in FIGS. 15-24, said clamping means have a dot or strip like pattern, depending on the individual decorative elements having substantially a small surface, such as flowers, as shown in FIG. 5A, or extending in a longitudinal direction, for example by branches with many flowers, not shown. In this connection it should be apparent that the configuration of the single elements 5, (forming the latching or clamping means, for example of a Velcro® type), can be freely selected, or they can be formed as small discs, square elements, rectangular elements and so on.

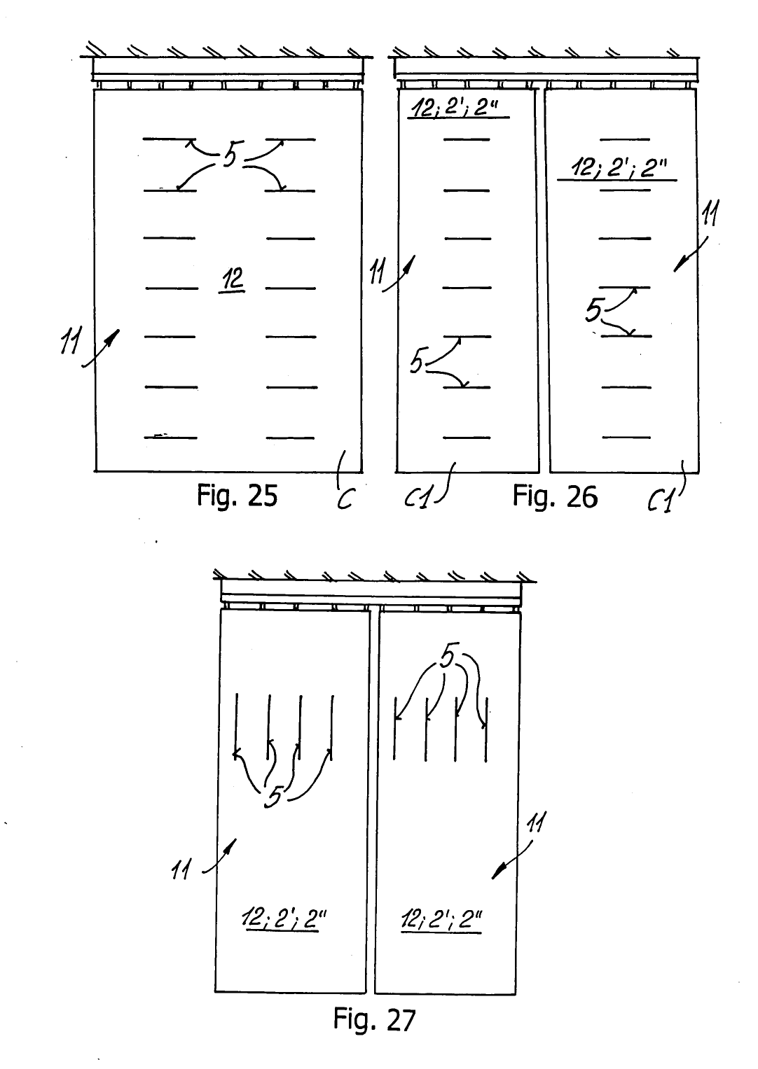

From said FIGS. 15 to 24 it should be apparent that the arrangement of said clamping means 5 can be freely selected: in particular, they can be arranged through the overall cross surface of the modules A to L, or in a linear arrangement, whereby, as shown in FIG. 17, the modules C can be cut either in a cross direction s (see the cross dash and dot line 21 providing a fictitious separation of the following modules) or with a longitudinal cut (see the fictitious dashed line 22) for forming two half-modules C1 as in the shown embodiment. Said modules C can be used, for example, for forming curtains for two-wing windows or door-windows (FIG. 25) whereas the half-modules C1 can be used for forming curtains for single-wing windows or door-windows (FIG. 26).

The clamping means 5 can be applied on the continuous cloth 15 in any desired suitable manners, for example by seaming, glueing, thermosealing or the like, depending on the construction of the cloth 15, which can be made either of natural, synthetic or mixed fibers. A seamed application can be advantageously made by sewing or embroidering machines including a plurality of operating heads, of a per se known construction. A like arrangement can be used in glueing or thermosealing machines, having operating heads designed for feeding an adhesive material, or providing thermosealing heating, as a synthetic material is used.

After application of the clamping means 5 according to the preset module, the strip or web will be fed according to the arrow F, with a step or pitch corresponding to the width of the set module, for a simultaneous application on the cloth 15 of the clamping means 5 of the following module, the succession of said modules comprising either equal or different modules with a freely selectable arrangement.

The machine for winding/rewinding the cloth 15 and related apparatus controlled by a suitable control software allows to set on the cloth 15 a desired succession of the target modules, by simple keyboard, touch-screen control operations or the like.

The transversal cutting operation 21 for separating the individual modules A, B, C, D, E, F, G, H, I, L, can be carried out by known cross displaceable cutters like those used in winding machines, whereas the longitudinal cuts 22 can be performed either by longitudinally operating cutters or by separated cutting machines, after having cross wise cut the cloth modules, as shown in 21.

A main feature of the invention is that the cutting of the continuous cloth is oerformed after having applied the clamping means 5.

According to a modified embodiment of the invention, said clamping means 5, in the form of loops or hook elements, can be applied on the cloth by chain stitches, obtained by known multiple sewing or embroidering machines, and directly made on the cloth alternately to the application of the clamping means 5, which are applied by seaming, glueing or the like operations.

It is also possible to provide said chain stitch patterns on the cloth 15 by injection molded synthetic threads.

If, as hereinabove mentioned, continuous cloth elements of suitable widths, for example of 3 m or 3.5 m are used, it is possible to obtain by cross wise cut/21 tablecloths, bedcovers, simple or double curtains, in a practically finished condition, or formed by a single cross strip or module from the cloth 1; moreover by longitudinal cuts 22 through the cloth 15 it is possible to provide strips of any desired lengths and widths, for example the half-modules C1 of FIG. 17, to be used for forming, for example, single-piece curtains, or curtains including ending and/or integrating strips either with or without inserts in the form of remnans, as shown for example in FIGS. 29 and 30.

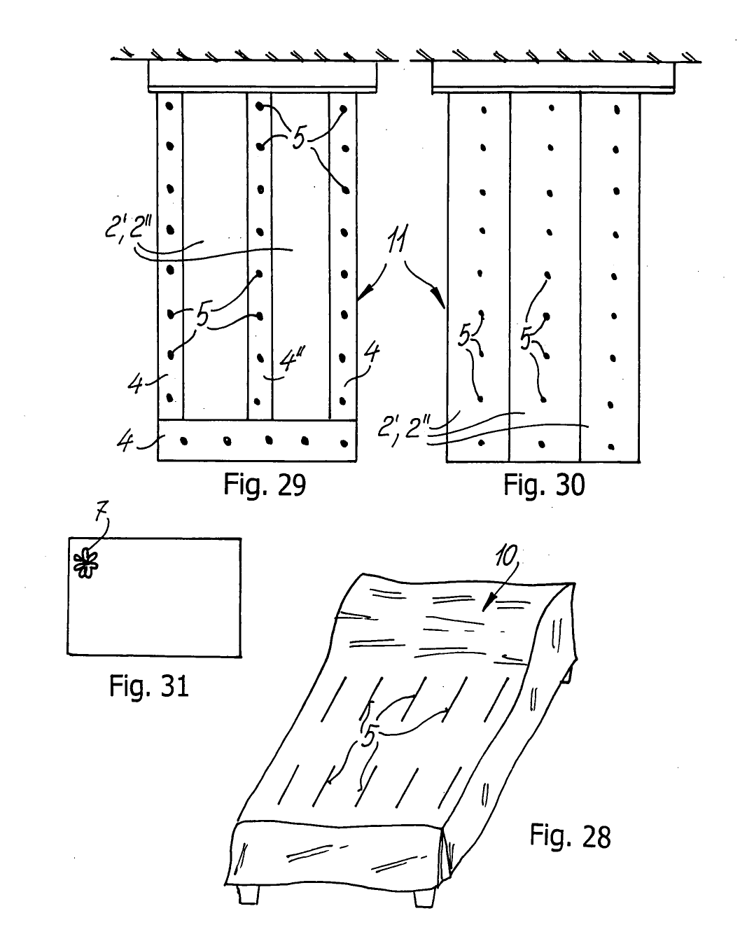

The bedcover shown in FIG. 28 can be made by crosswise cutting 21, for example a module C as shown in FIG. 17.

With using strips for example of 50 cms, it is possible to make known breakfast or American table-clothes, as shown in FIG. 31, including either one or more decorative elements.

From the structural and functional above disclosure of the termination/insert strips according to the present invention and the textile products therewith obtained as well as from the above disclosure related to the method and use of the textile products manufactured therewith, it should be apparent that the teachings of the invention allow to efficiently achieve the above mentioned objects and advantages, associated with an application of the clamping means on the continuous cloth, according to the above disclosed making criteria.

The clamping means 5 can be arranged either with an “all over” arrangement, i.e. in a continuous manner through the overall surface, or in a panel arrangement, i.e. according to a so-called placed pattern.

In practicing the invention, those skilled in the art could perform modifications and variations for example to the design or construction of said clamping means 5, and their application, the construction of other modules, or modules to be arranged on cloths including other ornamental elements made by embroidering operations or the like, and cloth elements of particular types and widths, without departing from the scope of the invention.

1. A perimetrical termination strip for textile products like tableclothes, bed spreads, window and balcony curtains and the like comprising a textile body which is monocolored, multicolored embroidered and so on, characterized in that
said strip is provided with decorative elements which may be removably associated by means of fastening means and counter-means in two parts, for example of the hook-and-loop fabric or Velcro® type, wherein a fastening means is secured to said termination strip and the counterfastening means is secured to a decorative element,
wherein said termination strip is also usable as an insert strip for the from time to time considered textile product,
in that said fastening means (5) secured to the termination and/or insert strip (4) are placed along an imaginary line (8) with a uniform or irregular pitch (T) or
along two or more imaginary lines (8, 9) with a uniform or irregular pitch and reciprocally offset from a line to the other.

2. Tablecloth, bed spreader or curtain comprising a tablecloth, bed spreader or curtain body, characterized in that they are provided with a perimetrical termination which is made with one or more termination strips according to claim 1.

3. Tablecloth, bed spreader or curtain according to claim 2, characterized in that they are provided with one or more insert strips (4′, 4″) which are transversally and/or longitudinally placed.

4. Tablecloth, bed spreader or curtain according to claim 3, characterized in that they are exlusively made of termination and/or insert strips (4′, 4″) which are transversally and/or longitudinally placed.

5. A method for manufacturing textile products having removable decorative elements, such as bedcovers, bedclothes, curtains and the like, said method providing to apply on the textile products clamping means adapted to cooperate with clamping counter-means applied to said decorative elements, or vice versa, for example as segments with loops and hook of a Velcro® type or the like according to claim 1, characterized in that said clamping means are directly applied, such as by seaming, glueing, thermosealing or the like, on a continuous cloth wound, during its unwinding/rewinding, as a step by step contemporaneous application phase by modules with a freely selectable pattern of said clamping means, before cutting said cloth either in a longitudinal or in a cross direction.

6. A method according to claim 5, characterized in that said clamping means are contemporaneously applied for each module, or plurality of modules, the individual or overall width thereof defines in the cross direction of the cloth, a simultaneous application step of said clamping means, which application step is set by a cloth length measurement device, comprising, for example, a directed software controlled meter counter or the like.

7. A method according to claim 6, characterized in that in each said module, said clamping means are so arranged as to provide any desired number and pattern of said clamping means through the overall surface of said module.

8. A method according to claim 5, characterized in that said clamping means are applied on a continuous cloth already subjected to all the required finishing treatments.

9. A method according to claim 5, characterized in that said clamping means are applied by corresponding thread-like loop or hook zones, by performing embroidering, seaming, injection molding, glueing operations or the like.

10. A method according to claim 5, characterized in that a continuous cloth comprising removable clamping means adapted to cooperate with clamping counter-means for removably clamping decorative elements is wound up to form a roll which can be cut in a cross or in a longitudinal direction to form perimetrical termination and/or integration strips or textile products like a tablecloth, a bed spreader or bedcover, a curtain, or the like.
